(19) United States
(12) Patent Application Publication
(10) Pub. No.: US 2014/0281793 A1
(43) Pub. Date: Sep. 18, 2014

(54) DATA DECODING ACROSS MULTIPLE TRACKS

(71) Applicant: SEAGATE TECHNOLOGY LLC, Cupertino, CA (US)

(72) Inventor: Ara Patapoutian, Hopkinton, MA (US)

(73) Assignee: SEAGATE TECHNOLOGY LLC, Cupertino, CA (US)

(21) Appl. No.: 13/834,216

(22) Filed: Mar. 15, 2013

(51) Int. Cl. G06F 11/10

(52) U.S. Cl. CPC G06F 11/10
USPC 714/758

(57) ABSTRACT

Devices and/or methods may store a data unit across multiple data tracks. Each of the data tracks may have different signal-to-noise ratios (SNR). The SNR, or bit error rate, of the data unit may be diversified by being stored across multiple different tracks.

The disclosure herein relates to decoding data located in multiple data tracks, and further to devices for performing and implementing such decoding.

### SUMMARY

One exemplary device (e.g., a data device for use in two-dimensional magnetic recording systems, shingled magnetic recording systems, bit-patterned media systems, heat-assisted magnetic recording systems, thermally assisted magnetic recording systems, energy assisted magnetic recording, solid state storage systems, flash storage systems, etc.) may include a storage medium and a processor operably coupled to the storage medium.

The storage medium may include a plurality of data tracks. Each data track of the plurality of data tracks may extend next to, or along side, of each other. The processor may be configured to read a first portion of a data unit from a first data track, read a second portion of the data unit from a second data track, read a parity portion associated with an error-correcting code (ECC) from one at least one of the first data track and the second data track, and decode the data unit using the parity portion.

Another exemplary device may include a storage medium and a processor operably coupled to the storage medium. The storage medium may include a plurality of data tracks. The processor may be configured to receive a data unit to write to the storage medium, write a first portion of the data unit to a first data track, write a second portion of the data unit to a second data track, and write a parity portion for the data unit associated with an error-correcting code (ECC) to at least one of the first data track and the second track.

One exemplary method may include acquiring a first portion of a data unit from a first data track from a plurality of data tracks of a storage medium, acquiring a second portion of the data unit from a second data track, acquiring a parity portion associated with an error-correcting code (ECC) from one at least one of the first data track and the second data track, and decoding the data unit using the parity portion.

Another exemplary method may include receiving a data unit to write to a storage medium, writing a first portion of the data unit to a first data track, writing a second portion of the data unit to a second data track, and writing a parity portion for the data unit associated with an error-correcting code (ECC) to at least one of the first data track and the second track.

One exemplary storage medium may include a plurality of data tracks configured to store data and a data unit stored on two or more data tracks. The data unit may include two or more data portions and a parity portion. Each data portion may be stored on a different data track of the plurality of data tracks. The parity portion may be associated with an error-correcting code (ECC) and may be configured to decode the data unit. In at least one embodiment, the parity portion may be stored on at least one of the first data track and the second track.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1 is block diagram including an exemplary device for use in detecting data.

FIG. 2 is a diagram of an exemplary method of writing a data unit to a storage medium

FIG. 3 is a flow diagram of an exemplary method of writing a data unit to a storage medium.

FIG. 4 is a diagram of an exemplary method of reading a data unit from a storage medium

FIG. 5 is a flow diagram of an exemplary method of rearing a data unit from a storage medium.

### DETAILED DESCRIPTION

As storage medium capacities have increased, data tracks located on such storage mediums have been located closer in proximity to each other, increasing storage density and capacity of storage media. As adjacent data tracks become closer, crosstalk (e.g., magnetic interference, etc.) between the adjacent tracks (e.g., known as inter-track interference), may become increasingly significant, such that data in a desired track cannot be read, leading to data corruption and other problems.

Interference from adjacent (or neighboring) tracks may occur during read operations, especially when a reader or head is employed that is not significantly narrower than the width of the data tracks. Also, when the reader is not precisely centered over the desired track to be read, additional interference from adjacent data tracks may be read. For example, a reader might receive signals from one or more adjacent (or neighboring) tracks, in addition to the signal from the desired track to be read.

Two-dimensional magnetic recording, or TDMR, is a technology can improve areal density and/or performance. In TDMR, two or more tracks may be detected simultaneously (e.g., using two or more heads) or used jointly for detection. Different data units, or segments, on different tracks may be associated with different signal-to-noise ratios (SNR), some having a higher SNR and some having a lower SNR. Furthermore, if data on different tracks is recorded separately, adjacent tracks may be negatively correlated. In other words, if track B is written after track A, it could squeeze track A, and then track B may end up with high SNR while track A will have a lower SNR.

The exemplary devices and methods described herein may take advantage varying SNRs. For example, an exemplary device may store a single data unit across two or more data tracks that have different SNRs. By storing the data unit across, or over, two or more data tracks having different SNRs, the SNR of the data unit may be effectively “averaged out” over the different SNRs.

For example, a single Error-Correction Code (ECC) can be used to cover two data portions, or segments, each located on a different track. With such a data structure or data storage architecture, the ECC may be utilized more efficiently since the data portion with the higher SNR may need less of the ECC power, and most of the ECC power may be diverted to the data portion with lower SNR, or the data portion that is in stress. Although the exemplary devices and/or methods described herein may be explained in reference to two data tracks, it is to be contemplated that the exemplary devices and/or methods may also be applied more than two tracks (n>2 tracks).

For example, if a first portion of a data unit is stored on a data track having a high SNR and a second portion of the data is stored on a data track having a low SNR, the SNR for the data unit when the first portion is combined with the second portion will be somewhere between the low SNR and high SNR. In other words, the data unit will have less bit errors such that data unit may have a higher likelihood of successful decoding using an Error-Correction Code (ECC), a higher likelihood of expedient decoding using an ECC, and/or a higher likelihood of lower amount of iterations using an iterative decoder.

An exemplary device 10 (e.g., data device) that can be used in the embodiments described herein is depicted in FIG. 1. The exemplary device 10 may be operably coupled to a local host 15, e.g., for transferring data therebetween, as shown in FIG. 1. For example, the local host 15 may request data from the device 10 and the device 10 may provide such requested data to the local host 15 or the local host 15 may send data to the device 10 to be stored. In at least one embodiment, the local host 15 is a computer (such as, e.g., a personal computer, server, etc.). The device 10 includes a storage medium 12, a buffer (e.g., for storing data during read and write operations), and a processor, or processing apparatus, 14 that are operably coupled (e.g., electrically coupled to transmit data therebetween) to each other. The methods and devices disclosed herein may be generally described in the context of exemplary device 10 and/or systems including exemplary device 10, but that should in no way be taken as limiting the scope of the present disclosure. Generally, a device 10 may be any device and/or apparatus in which data may be written to the storage medium 12 and then read back from the storage medium 12.

An exemplary storage medium 12 as shown in FIG. 2 may be any device and/or apparatus configured to store a plurality of data tracks, or tracks of data, 16 (e.g., binary data, etc.). Each data track 16 may contain a plurality of data (e.g., the data may be grouped in portions, sectors, etc.). The storage medium 12 can include, but is not necessarily limited to, solid state memory, hard magnetic discs, magnetic tapes, optical discs, integrated circuits, volatile memory, non-volatile memory, etc. Generally, the plurality of data tracks 16 may be contained in non-volatile memory.

Non-volatile memory may include any kind of computer memory that can retain information stored thereon when not powered. Examples of non-volatile memory may include, but are not limited to, hard drives, solid state drives, read only memory (ROM), flash memory, and random access memory (RAM). Examples of ROM include, but are not limited to, programmable ROM (PROM) which can also be referred to as field programmable ROM; electrically erasable programmable ROM (EEPROM) which is also referred to as electrically alterable ROM (EAROM); and erasable programmable ROM (EPROM). Examples of RAM include, but are not limited to, ferroelectric RAM (FeRAM or FRAM); magnetoresistive RAM (MRAM); resistive RAM (RRAM); non-volatile static RAM (nvSRAM); battery backed static RAM (BBSRAM); phase change memory (PCM) which is also referred to as PRAM, PCRAM and C-RAM; programmable metallization cell (PMC) which is also referred to as conductive-bridging RAM or CBRAM; nano-RAM (NRAM), spin torque transfer RAM (STTRAM) which is also referred to as STRAM; and Silicon-Oxide-Nitride-Oxide-Silicon (SONOS), which is similar to flash RAM.

Each data track, or track of data, 16 of the plurality of data tracks 16 of the storage medium 12 may be generally described as including a plurality of data (e.g., sectors of data, pages of data, cells of data, units of data, etc.). For example, each data track may be subdivided in a plurality of data segments.

In at least one embodiment, the storage medium 12 may include one or more magnetic discs. Each disc in an exemplary storage medium 12 may include a surface having a plurality of substantially concentric circular data tracks 16. Each of the concentric circular data tracks 16 may be adjacent to other data tracks: one data track to the inside and one data track to the outside. In at least one embodiment, the storage medium 12 may be a solid state drive. The solid state drive may include a plurality of data tracks 16, and each of the data tracks 16 may be adjacent to other data tracks (e.g., physically located in proximity to another track, which may cause capacitance interference between data units). As used herein, adjacent data tracks may be defined as data tracks that are next to each other. In at least one embodiment, adjacent tracks may be tracks that are immediately next to each other (e.g., with no other tracks therebetween).

The processor 14 may include various circuitry, logic, memory, etc. for use in the detecting and writing data from the storage medium 12 and/or managing data within a buffer. For example, the processor 14 may include one or more circuit components such as integrated circuits, processors, etc. that may be configured to interface with the storage medium 12 and a buffer to read/detect, write, and decode data. Among other things, the processor 14 may be configured to write/encode and/or read/decode a data unit 22 located across, or stored on, two or more data tracks 16.

The methods, techniques, and/or processes described in this disclosure, including those attributed to the processor, or various constituent components, may be implemented, at least in part, in hardware, software, firmware, or any combination thereof. For example, various aspects of the techniques may be implemented within one or more processors, including one or more microprocessors, DSPs, ASICs, FPGAs, or any other equivalent integrated or discrete logic circuitry, as well as any combinations of such components. The term “processing apparatus,” “processor,” or “processing circuitry” may generally refer to any of the foregoing logic circuitry, alone or in combination with other logic circuitry, or any other equivalent circuitry.

Such hardware, software, and/or firmware may be implemented within the same device or within separate devices to support the various operations and functions described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, the functionality ascribed to the systems, devices and techniques described in this disclosure may be embodied as instructions on a computer-readable medium such as RAM, ROM, NVRAM, EEPROM, FLASH memory, STRAM, RRAM, magnetic data storage media, optical data storage media, or the like. The instructions may be executed by one or more processors to support one or more aspects of the functionality described in this disclosure.

An exemplary method of writing data 20 is depicted in FIGS. 2-3. The method 20 may receive a data unit 22, e.g., from the local host 15, to be stored on the storage medium 12 (Block 32). A parity portion 24 for the data unit 22 may be generated (Block 34) using an exemplary Error-Correction Code (ECC). Exemplary ECC that can be utilized include, but are not limited to, linear codes and systematic codes. Specific examples of ECC (e.g., forward error correction code) that can be utilized include, but are not limited to, Hamming codes, BCH codes, Reed-Solomon codes, Reed-Muller codes, Golay codes (such as Binary Golay codes), low density parity-check (LDPC) codes, Berger codes, constant-weight codes, convolutional codes, fountain codes (such as erasure codes, raptor codes or tornado codes), group codes, Goppa codes, Hadamard codes, LT codes, repeat-accumulate codes, sparse graph codes, turbo codes, walsh codes, single parity codes, and interleaved codes. In at least one embodiment, LDPC is utilized.

Exemplary ECC that can be utilized may include non-systematic codes. For example, the parity portion 24 when using non-systematic codes may be part of, built into, or inherent within, the data portions 26 themselves. As such, the parity portion 24 may be read, or written, at the same time as the data portions 26 since it may be part thereof.

The data unit 22 and the parity portion 24 may then be written to the storage medium 12 (Blocks 36, 38, & 40). As described herein, the data unit 22 may be split into two or more data portions 26 to be stored across two or more data tracks 16. For example, in the case where the data unit 22 is split into two data portions 26 such as a first data portion 26 and a second data portion 26, a first data portion 26 may be stored in a first data track 16 and a second data portion 26 may be stored in a second data track 16. Since the first data track 16 and the second data track 16 may have a different SNR, the SNR for the data unit may be effectively “averaged out,” or diversified, across the two data tracks 16.

Additionally, each of the data tracks 16 within which the data portions 26 of the data unit 22 are stored may be located adjacent to each other. As such, in a two-dimensional magnetic recording system, each of data portions 26 of the data unit 22 may be read simultaneously (e.g., using a multiple head reader/detector, etc.). For example, in at least one embodiment, two or more data portions 26 of the data unit 22 may read simultaneously from adjacent tracks 16.

Further, a data unit 22 may be stored across, or in, more than two tracks 16 such as, e.g., two or more data tracks, three or more data tracks, four or more data tracks, six or more data tracks, eight or more data tracks, etc. For example, in the case where the data unit 22 is split into three data portions 26 such as a first data portion 26, a second data portion 26, and a third data portion 26, a first data portion 26 may be stored in a first data track 16, a second data portion 26 may be stored in a second data track 16, and a third data portion 26 may be stored in a third data track 16. Since the first data track 16, the second data track 16, and the third data track 16 may have a different SNR, the SNR for the data unit may be effectively “averaged out,” or “diversified,” across the three data tracks 16.

As shown in FIG. 2, a data unit 22 may be stored within, or across, n-th data tracks, or a plurality of data tracks. As such, a first data portion 24 may be written, or stored, on a first data track 16 (Block 36) and n-th data portion 24 may be written, or stored, on n-th data track 16 (Block 38).

The exemplary method 20 may continue to store, or write, the parity portion 24 for the data unit 22 on the storage medium 12 (Block 40). Although depicted sequentially, the parity portion 24 may be stored, or written, as the same time as one of the data portions 26. The parity portion 24 may be stored on the same track or a different track as any one of the data portions 26 of the data unit 22. For example, if a data portion 26 is written on the first data track 16, the parity portion 24 may be written on the first data track 16 or another data track 16. Additionally, the parity portion 24 may be written adjacently, or next, to one of the data portions 26 in the same track 16. In at least one embodiment, the parity portion 24 may be stored on a data track 16 that does not include any of the data portions 26 of the data unit 22.

Further, the parity portion 24 may be stored in more than one track 16. For example, a part of the parity portion 24 may be stored in each of the data tracks 16 that a data portion 26 for a particular data unit 22 is stored. For example, a part of the parity portion 24 may be stored in two or more but not all of the data tracks 16 that a data portion 26 for a particular data unit 22 is stored. In other words, the parity portion 24 may also be effectively “averaged out,” or “diversified,” across multiple tracks 16.

In essence, the exemplary method 20 may have created, or provided, an exemplary data structure 21 on the storage medium 12. The data structure 21 may include one or more data units 22 stored on two or more data tracks 16. The data unit 22 may include two or more data portions 26 and a parity portion 24. Each data portion 26 may be stored on a different data track 16. The parity portion 24 may be associated with an ECC and may be configured to decode the data unit 22 made up of the two or more data portions 26.

For example, consider a data unit 22 with an exemplary size of four kilobytes (other sizes can include 512 bytes, 2048 bytes or more than 4K). In a TDMR system, half the data unit 22, or a first data portion 26 (e.g., two kilobytes), could be stored one data track 16 and the second half of the data unit 22, or a second data portion 26 (e.g., two kilobytes), could be stored another data track 16 such as the adjacent data track 16. A single ECC could cover both halves or portions 26. Whether the parity portion 24 is distributed on the first data portion and/or second data portion 26 (e.g., on one or both data tracks 16) does not make a difference. At the decoder side, the two data portions 26, or segments, are detected, either jointly or separately. In general, the errors in one data portion 26 will dominate, and the ECC will divert most of its power to correct the weaker data portion 26.

An exemplary method of reading data 50 is depicted in FIGS. 4-5. Although not shown, the method 50 may receive a request for a data unit 22, e.g., from the local host 15, to be read from the storage medium 12 and delivered to the local host 15. Each of the data portions 26 of the requested data unit 22 may be acquired (e.g., read, or detected, from a detector block) (Block 52). As described herein, the data unit 22 may be split across multiple data portions 26 stored on multiple data tracks 16, and as such, each of the data portions 26 must be acquired to decode the data unit 22. For example, if the data unit 22 was stored as two data portions 26 such as a first data portion 26 and a second data portion 26, each of the first and the second data portions 26 must be acquired.

Next, the parity portion 24 for the data unit 22 may be acquired, or read, from one or more data tracks 16 (Block 54) and combined as shown in FIG. 4. The first data portion 26 may represent a high bit error rate (e.g., low SNR) region 42, and the n-th data portion 26 and the parity portion 24 may represent a low bit error rate (e.g., high SNR) region 44. As a result, the bit error rate, or SNR, of the entire data unit 22 and parity portion 24 may be effectively “averaged out,” or “diversified,” across a high bit error rate and a lower bit error rate to provide a bit error rate somewhere therebetween. As a result, the data unit 22 may have a higher likelihood of successful decoding, a higher likelihood of expedient decoding, and/or a higher likelihood of lower amount of iterations using an iterative decoder.

Additionally, each of the data tracks 16 within which the data portions 26 of the data unit 22 and the parity portion 24 are stored may be located adjacent to each other. As such, in a two-dimensional magnetic recording system, each of data portions 26 of the data unit 22 and the parity portion 24 may be read or acquired simultaneously (e.g., using a multiple head reader/detector, etc.). For example, in at least one embodiment, two or more data portions 26 of the data unit 22 and the parity portion 24 may read simultaneously from adjacent tracks 16.

The exemplary method 50 may next decode the data unit 22 using an exemplary Error-Correction Code (ECC) (Block 56). After the data unit 22 has been decoded, the data unit 22 may be delivered to the requester such as, e.g., the local host 15.

In the preceding description, reference is made to the accompanying set of drawings that form a part hereof and in which are shown by way of illustration several specific embodiments. It is to be understood that other embodiments are contemplated and may be made without departing from (e.g., still falling within) the scope or spirit of the present disclosure. The preceding detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g., 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The implementations described above and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

Exemplary methods and devices were described with reference to FIGS. 1-5. It is apparent to one skilled in the art that elements or processes from one embodiment may be used in combination with elements or processes of the other embodiments, and that the possible embodiments of such methods and devices using combinations of features set forth herein is not limited to the specific embodiments shown in the figures and/or described herein. Further, it will be recognized that timing of the processes and the size and shape of various elements herein may be modified but still fall within the scope of the present disclosure, although certain timings, one or more shapes and/or sizes, or types of elements, may be advantageous over others.

What is claimed is:

1. A device comprising:
a storage medium comprising a plurality of data tracks; and
a processor operably coupled to the storage medium and configured to:
read a first portion of a data unit from a first data track;
read a second portion of the data unit from a second data track;
read a parity portion associated with an error-correcting code (ECC) from one at least one of the first data track and the second data track; and
decode the data unit using the parity portion.

2. The device of claim 1, wherein the parity portion is located adjacent the first portion in the first track.

3. The device of claim 1, wherein the first data track is adjacent the second data track.

4. The device of claim 1, wherein the processor is further configured to acquire a third portion of the data unit from a third data track.

5. The device of claim 1, wherein reading the first portion of the data unit from the first data track and reading the second portion of the data unit from the second data track occur simultaneously.

6. The device of claim 1, wherein a signal-to-noise ratio (SNR) of the first portion of the data unit is different than the SNR of the second portion of the data unit.

7. A device comprising:
a storage medium comprising a plurality of data tracks; and
a processor operably coupled to the storage medium and configured to:
receive a data unit to write to the storage medium;
write a first portion of the data unit to a first data track;
write a second portion of the data unit to a second data track; and
write a parity portion for the data unit associated with an error-correcting code (ECC) to at least one of the first data track and the second track.

8. The device of claim 7, wherein the parity portion is located adjacent the first portion in the first track.

9. The device of claim 7, wherein the first data track is adjacent the second data track.

10. The device of claim 7, wherein the processor is further configured to write a third portion of the data unit to a third data track.

11. The device of claim 7, wherein the storage medium is configured for two-dimensional magnetic recording.

12. The device of claim 8, wherein a signal-to-noise ratio (SNR) of the first portion of the data unit is different than the SNR of the second portion of the data unit.

13. A method comprising:
acquiring a first portion of a data unit from a first data track from a plurality of data tracks of a storage medium;
acquiring a second portion of the data unit from a second data track;
acquiring a parity portion associated with an error-correcting code (ECC) from one at least one of the first data track and the second data track; and
decoding the data unit using the parity portion.

14. The method of claim 13, wherein the parity portion is located adjacent the first portion in the first track.

15. The method of claim 13, wherein the first data track is adjacent the second data track.

16. The method of claim 13, wherein the method further comprises acquiring a third portion of the data unit from a third data track.

17. The method of claim 14, wherein reading the first portion of the data unit from the first data track and reading the second portion of the data unit from the second data track occur simultaneously.

18. The method of claim 14, wherein a signal-to-noise ratio (SNR) of the first portion of the data unit is different than the SNR of the second portion of the data unit.

19. A method comprising:
receiving a data unit to write to a storage medium;
writing a first portion of the data unit to a first data track;
writing a second portion of the data unit to a second data track; and
writing a parity portion for the data unit associated with an error-correcting code (ECC) to at least one of the first data track and the second track.

20. The method of claim 20, wherein the parity portion is located adjacent the first portion in the first track.

21. The method of claim 20, wherein the first data track is adjacent the second data track.

22. The method of claim 20, wherein the method further comprises writing a third portion of the data unit to a third data track.

23. The method of claim 20, wherein the storage medium is configured for two-dimensional magnetic recording.

24. The method of claim 20, wherein a signal-to-noise ratio (SNR) of the first portion of the data unit is different than the SNR of the second portion of the data unit.
